(19) United States
(12) Patent Application Publication
(10) Pub. No.: US 2011/0304223 A1
(43) Pub. Date: Dec. 15, 2011

(54) PORTABLE TERMINAL

(75) Inventor: Daisuke Togashi, Yokohama-shi (JP)

(73) Assignee: KYOCERA CORPORATION, Kyoto-shi (JP)

(21) Appl. No.: 13/202,684

(22) PCT Filed: Feb. 25, 2010
(86) PCT No.: PCT/JP2010/001284

§ 371 Date: Aug. 22, 2011

(30) Foreign Application Priority Data
Feb. 25, 2009 (JP) 2009-042749

(51) Int. Cl. H01H 35/00

(52) U.S. Cl. 307/116

(57) ABSTRACT

A portable terminal is provided that can carry out adjustment of reception sensitivity with ease. A portable terminal (1) comprises a first body (2); a second body (3); a ground portion (31); a circuit (33) having a power feed portion (32) and a signal processing unit (36); a first conductive portion (34) disposed in the first body (2) and is electrically connected to the ground portion (31); a second conductive portion (35) and a third conductive portion (37) disposed in the second body (3); a selection portion (64) which can select between a first connection state in which the second conductive portion (35) and power feed portion (32) are connected and a second connection state in which the third conductive portion (37) and power feed portion (32) are connected; and a control unit (63) that controls selection of the first connection state or second connection state by way of the selector portion (64),in which the control unit (63) compares the between a reception sensitivity in the first connection state and reception sensitivity in the second connection state, and controls the selection portion (64) so as to select the connection state which is higher reception sensitivity.

### CROSS-REFERENCE TO RELATED APPLICATIONS

This application is the National Stage of International Application No. PCT/JP2010/001284, filed Feb. 25, 2010, which claims the benefit of Japanese Application No. JP 2009-042749, filed Feb. 25, 2009, the contents of which are incorporated by reference herein.

### TECHNICAL FIELD

The present invention relates to a portable terminal having a first body and a second body.

### BACKGROUND ART

Among portable terminals, there is a folding-type terminal that is configured from a first body and a second body and is configured to be able to transition between an opened state and a closed state via a hinge portion according to a usage mode. Such a folding-type portable terminal has a communication function of communicating externally via an antenna. Herein, when used by a user while performing communication, the amplification drops due to the influence of the human body according to the usage mode thereof, and the antenna of the portable terminal becomes unable to secure high communication quality.

Therefore, a technique has been proposed to secure high communication quality irrespective of the usage mode, by supplying power to one of a first conductive portion disposed in the first body and a second conductive portion disposed in the second body, and setting the other one to ground (grounded state). For example, according to Japanese Unexamined Patent Application Publication No. 2002-335180, it is possible to suppress a decline in the amplification of the antenna even if a portion is covered by the hand of the user, by employing either one of the first conductive portion and the second conductive portion as an antenna.

[Patent Document 1] Japanese Unexamined Patent Application, Publication No. 2002-335180

### DISCLOSURE OF THE INVENTION

### Problems to be Solved by the Invention

However, it is difficult to secure high communication quality depending on the usage mode, even with the technology disclosed in Japanese Unexamined Patent Application Publication No. 2002-335180. Therefore, technology has been demanded that can achieve a further improvement in communication quality.

The present invention has been made taking the aforementioned such problems into account, and one of the objects thereof is to provide a portable terminal that can achieve a further improvement in communication quality.

### Means for Solving the Problems

In order to solve the above-mentioned problems, a portable terminal according to the present invention includes: a first body; a second body; a circuit portion that is disposed in either of the first body and the second body, and comprises a ground portion, a power feed portion, and a signal processing unit connected to the power feed portion; a first conductive portion that is disposed in the first body and is electrically connected to the ground portion; a second conductive portion and a third conductive portion that are disposed in the second body; a selector portion that can select a connection state of the second conductive portion and the third conductive portion with the power feed portion; and a control unit that controls selection of the connection state by way of the selector portion.

In addition, it is preferable for the selector portion to be able to select between a first connection state in which the second conductive portion and the power feed portion are connected, and a second connection state in which the third conductive portion and the power feed portion are connected, and for the control unit to compare between a reception sensitivity in the first connection state and a reception sensitivity in the second connection state, and control the selector portion so as to select a connection state which is a higher reception sensitivity.

Furthermore, it is preferable for the selector portion to be able to select a third connection state in which the second conductive portion and the third conductive portion are connected with the power feed portion, and for the control unit to control the selector portion to select the third connection state in a case of a useable frequency band being no more than a predetermined value.

Additionally, it is preferable for the selector portion to be able to select between a fourth connection state in which the second conductive portion and the power feed portion are connected and the third conductive portion and the power feed portion are connected, and a fifth connection state in which the second conductive portion and the power feed portion are connected or the third conductive portion and the power feed portion are connected, and for the control unit to control the selector portion so as to select either the fourth connection state or the fifth connection state based on a predetermined condition.

Moreover, it is preferable for the control unit to use whether or not a reception sensitivity in the fourth connection state is no more than a predetermined threshold value as the predetermined condition, and to control the selector portion so as to select the fifth connection state in a case of the reception sensitivity in the fourth connection state being no more than the predetermined threshold value.

In addition, it is preferable for the control unit to use a comparison between a reception sensitivity in the fourth connection state and a reception sensitivity in the fifth connection state as the predetermined condition, and to control the selector portion so as to select a connection state which is a higher reception sensitivity.

Furthermore, it is preferable for a case member to be disposed in the second body, and for the control unit to use detection of contact with the second body and the case member as the predetermined condition, and to control the selector portion so as to select the third conductive portion and the power feed portion in the fourth connection state and the fifth connection state in a case of contact with the second body being detected, and to control the selector portion so as to select the second conductive portion and the power feed portion in the fourth connection state and the fifth connection state in a case of contact with the case body being detected.

Additionally, it is preferable for the control unit to use whether or not to suppress electric power consumption of the portable terminal as the predetermined condition, and to control the selector portion so as not to select the fourth connection state and the fifth connection state in a case of suppressing electric power consumption, and so as to select the fourth connection state or the fifth connection state in a case of not suppressing electric power consumption.

Moreover, it is preferable for the control unit to control the selector portion so as to select the fourth connection state or the fifth connection state based on an input operation related to a predetermined application program as the predetermined condition.

In addition, in the above-mentioned portable terminal, it is preferable for a case member to be disposed in the second body, and for either one of the second conductive portion and the third conductive portion to be formed at the case member.

Furthermore, in the above-mentioned portable terminal, it is preferable for the case member to be coupled to the second body to be relatively moveable in relation to the second body.

Additionally, in the above-mentioned portable terminal, it is preferable for the case member to be formed of a metal.

Moreover, in the above-mentioned portable terminal, it is preferable for the case member to be a decoration case.

### EFFECTS OF THE INVENTION

According to the present invention, it is possible to provide a portable terminal that can achieve a further improvement in communication quality.

### BRIEF DESCRIPTION OF THE DRAWINGS

FIG. 1 is a view showing an external appearance of a cellular telephone device according to the present embodiment;

FIG. 2 is an exploded perspective view of an operation unit side body of the cellular telephone device according to the present embodiment;

FIG. 3 is an exploded perspective view of a display unit side body of the cellular telephone device according to the present embodiment;

FIG. 4 is a view schematically showing a configuration of the cellular telephone device according to the present embodiment;

FIG. 5 is a view schematically showing a configuration of the cellular telephone device according to the present embodiment;

FIG. 6 is a view schematically showing an appearance when a first case member is connected to the operation unit side body;

FIG. 7 is a view schematically showing a variation of the first case member;

FIG. 8 is a view schematically showing a configuration of the cellular telephone device according to the present embodiment;

FIG. 9 is a view schematically showing an appearance when a second case member is connected to the display unit side body;

FIG. 10 is a view schematically showing a variation of the second case member;

FIG. 11 is a view schematically showing a configuration of the cellular telephone device according to the present embodiment;

FIG. 12 is a view schematically showing a configuration of the cellular telephone device according to the present embodiment;

FIG. 13 is a view schematically showing a configuration of the cellular telephone device according to the present embodiment;

FIG. 14 is a graph showing the relationship of the useable frequency band of a radiating element of an antenna;

FIG. 15 is a view schematically showing a configuration of the cellular telephone device according to the present embodiment; and

FIG. 16 is a view schematically showing a configuration of the cellular telephone device according to the present embodiment.

### PREFERRED MODE FOR CARRYING OUT THE INVENTION

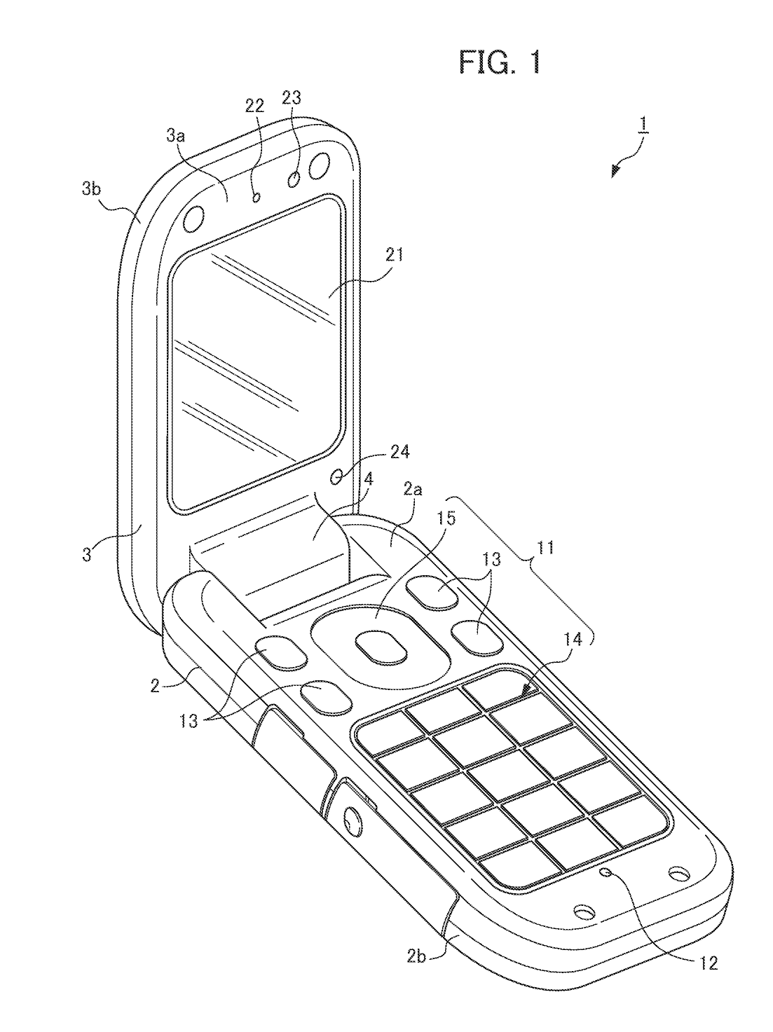

Embodiments of the present invention will be explained hereinafter. FIG. 1 shows a perspective view of the external appearance of a cellular telephone device 1, which is one example of a portable terminal according to the present invention. It should be noted that, although the cellular telephone device 1 will be explained hereinafter, the present invention is not to be limited to cellular telephone devices, and may be a PHS (Personal Handyphone System), PDA (Personal Digital Assistant), portable navigation device, notebook computer or the like, for example.

As shown in FIG. 1, the cellular telephone device 1 includes an operation unit side body 2 and a display unit side body 3. The operation unit side body 2 (first body) and the display unit side body 3 (second body) are connected such that opening and closing thereof are possible via a connection portion 4 having a hinge mechanism. More specifically, an upper end portion of the operation unit side body 2 and a lower end portion of the display unit side body 3 are connected via the connection portion 4. The cellular telephone device 1 is thereby made such that it is possible to move the operation unit side body 2 and the display unit side body 3, which are connected via the hinge mechanism, relative to each other. That is, the cellular telephone device 1 can be in a state (opened state) in which the operation unit side body 2 and the display unit side body 3 are opened, and in a state (closed state) in which the operation unit side body 2 and the display unit side body 3 are arranged to overlap each other. Herein, the closed state is a state in which both bodies are disposed so as to overlap each other, and opened state refers to a state in which both bodies are disposed so as not to overlap each other.

An outer surface of the operation unit side body 2 is configured by a front case 2a and a rear case 2b. The operation unit side body 2 is configured so that, at its front case 2a side, a group of operation keys 11 and a voice input unit 12, which serves as a microphone to which sounds produced by the user of the cellular telephone device 1 during a call are input, are each exposed.

The group of operation keys 11 is configured with a function setting operation key 13 for running various functions such as various settings, a telephone directory function, a mail function, and the like, an input operation key 14 for inputting numbers of a telephone number, characters of mail and the like, for example, and a selection operation key 15 as an operation member to perform selections in various operations, scrolling in up, down, left and right directions, and the like. A predetermined function is assigned to each key constituting the group of operation keys 11 according to the opened or closed state of the operation unit side body 2 and the display unit side body 3, various modes, the type of application running, or the like (key assigning). Then, an operation is executed according to the function assigned to each key by the user pressing the respective keys.

The voice input unit 12 is arranged at an outer end portion side of the operation unit side body 2 opposite to the connection portion 4 side in the longitudinal direction. That is, the voice input unit 12 is arranged at one outer end portion side when the cellular telephone device 1 is in the opened state.

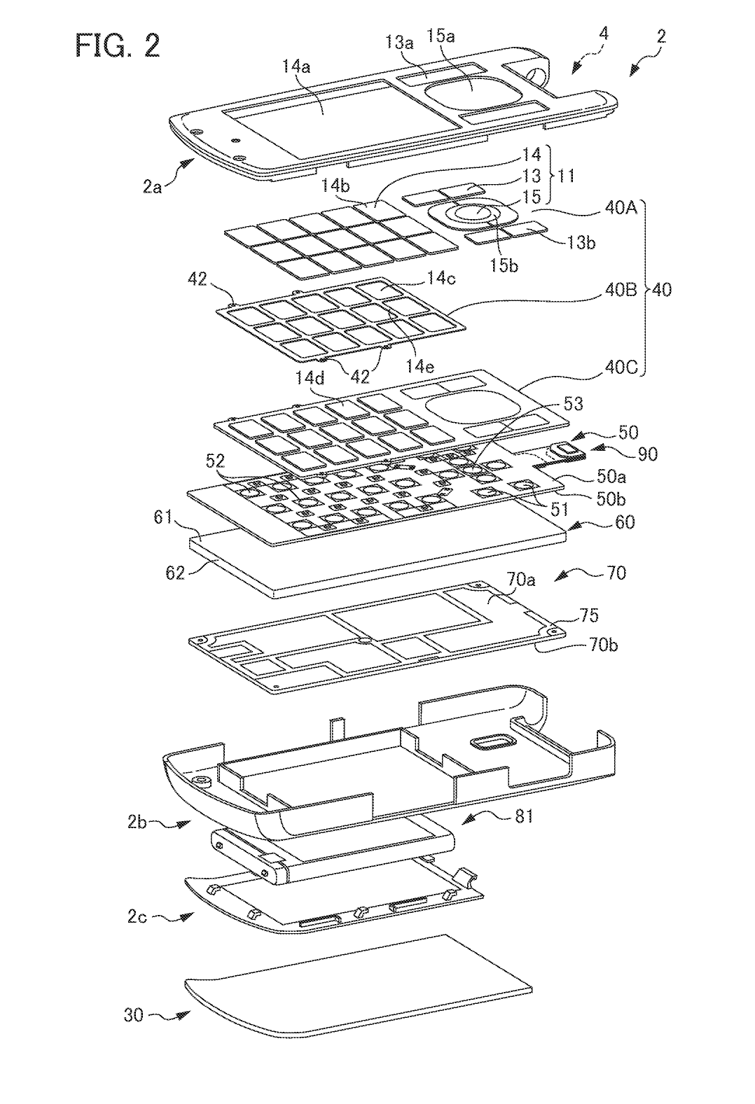

On a side face of one side of the operation unit side body 2, an interface (not illustrated) for carrying out communication with external devices (e.g., a host device) is arranged. On a side face of the other side of the operation unit side body, a side key to which a predetermined function is assigned and an interface (not illustrated) with which insertion and removal of external memory are performed are arranged. The interface is covered with a cap. Each interface is covered with a cap when not in use. A first case member 30 is disposed at an outer surface of the rear case 2b of this operation unit side body 2 (refer to FIG. 2).

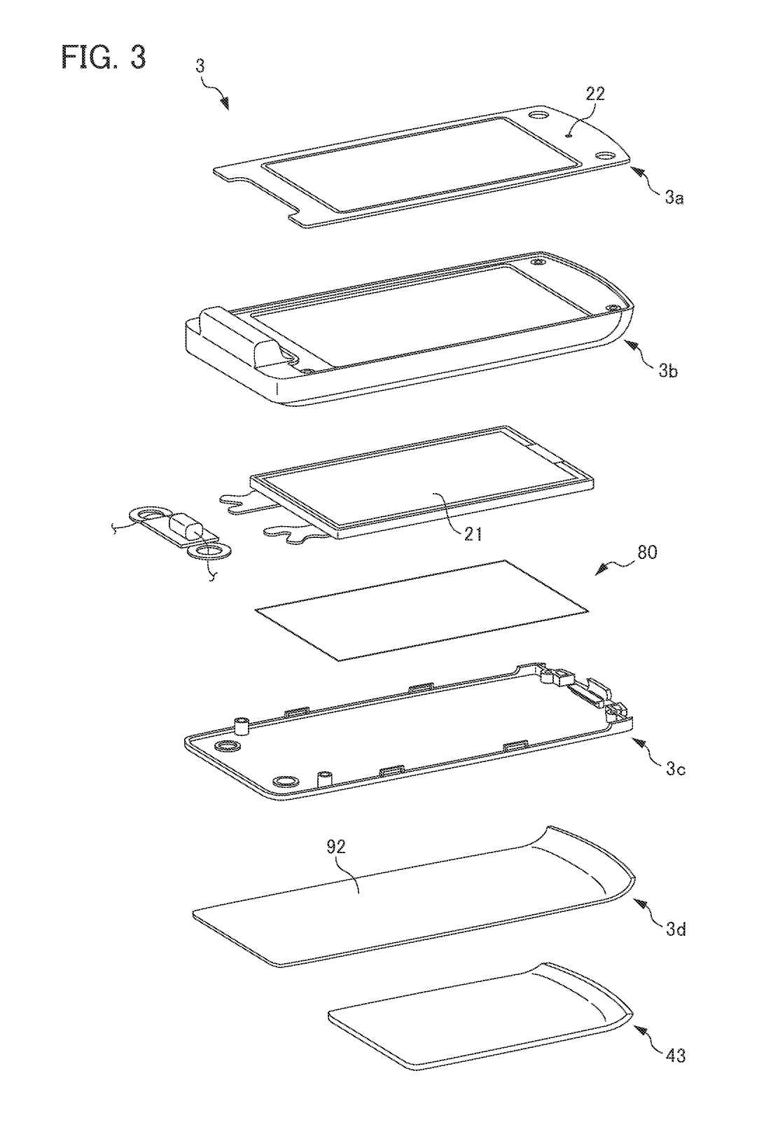

An outer surface of the display unit side body 3 is configured by a front panel 3a, a front case 3b, a rear case 3c, and a rear panel 3d (refer to FIG. 3). In addition, a second case member 43 serving as a case member is disposed at the outer surface of the rear panel 3d (refer to FIG. 3). A display unit 21 for displaying a variety of information, a voice output unit 22 as a receiver that outputs sound of the other party of a call, a photographing unit 23 configured by a CCD (Charge Coupled Device) camera or the like that photographs a subject, and a speaker 24 that outputs music and the like to outside are arranged in the display unit side body 3 so as to be externally exposed. The display 21 is configured from a liquid crystal panel, a drive circuit that drives this liquid crystal panel, and a light source unit such as a back light that radiates light from a back side of this liquid crystal panel.

FIG. 2 is an exploded perspective view of the operation unit side body 2. As shown in FIG. 2, the operation unit side body 2 includes a front case 2a, a key structure portion 40, a key substrate 50, a shielding case 60, a circuit board 70, a rear case 2b provided with a battery lid 2c, a first case member 30 and a battery 81.

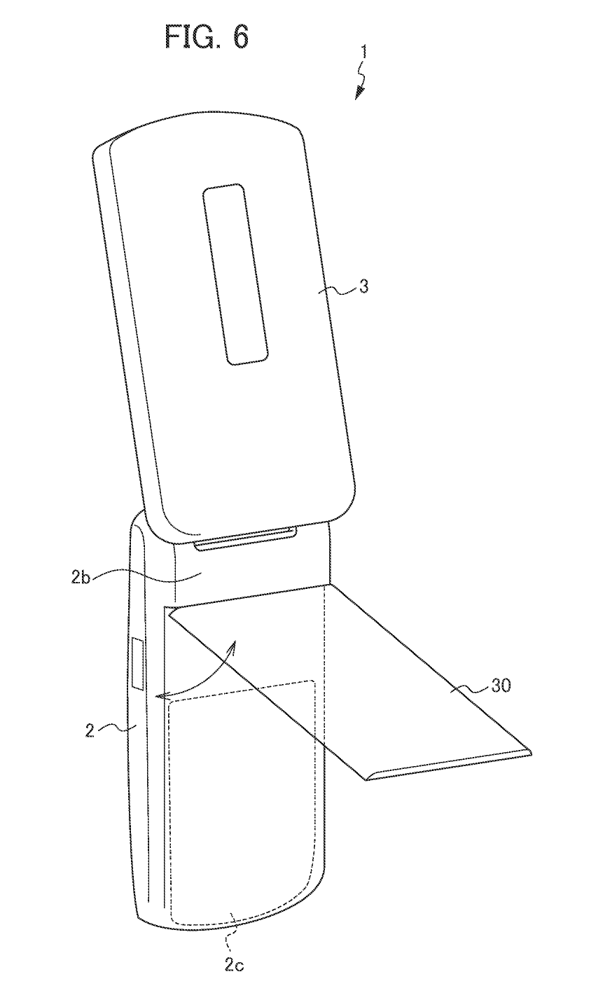

The front case 2a and the rear case 2b are arranged so that their concave-shaped internal surfaces face each other and their outer circumferential edges overlap each other. In addition, the first case member 30 is connected to the outer surface of the rear case 2b. This first case member 30 is connected to be relatively moveable in relation to the rear case 2b (refer to FIG. 6). In addition, the key structure portion 40, the key substrate 50 having an FPC portion 90, the shielding case 60, and the circuit board 70 are disposed between the front case 2a and the rear case 2b so as to be sandwiched therebetween.

Key holes 13a, 14a and 15a are formed in the front case 2a in an internal surface that faces the display 21 of the display unit side body 3 in a state in which the cellular telephone device 1 is folded. From each of the key holes 13a, 14a and 15a, a pressing surface of the function setting operation key member 13b constituting the function setting operation key 13, a pressing surface of the input operation key member 14b constituting the input operation key 14, and a pressing surface of the selection operation key member 15b constituting the selection operation key 15 are exposed. By pressing the pressing surfaces of the thus exposed function setting operation key member 13b, input operation key member 14b, and determination operation key member 15b, the top of a metal dome (bowl-shaped), which is described later, provided at each of the corresponding key switches 51, 52, and 53 is pressed and contacts a switch terminal to be electrically conducted to it.

The key structure portion 40 is configured with an operation member 40A, a key frame 40B as a reinforcement member, and a key sheet 40C as a sheet member.

The operation member 40A is configured with a plurality of key operation members. Specifically, it is configured with a function setting operation key member 13b, input operation key members 14b, and a selection operation key member 15b. Each of the operation key members constituting the operation member 40A is adhered to the key sheet 40C to sandwich the key frame 40B described later. The pressing surface on each of the operation key members adhered to the key sheet 40C is arranged to be exposed externally from each of the key holes 13a, 14a and 15a, as described above.

The key frame 40B is a metallic plate-shaped member in which a plurality of hole portions 14c are formed. The key frame 40B is a reinforcement member for preventing adverse effects on the circuit board 70 or the like due to pressing of the input operation key member 14b. In addition, the key frame 40B is an electrically conductive member, and functions also as a member for releasing static electricity in the input operation key member 14b. Convex portions 14d formed on the key seat 40C described later are arranged to fit to the plurality of hole portions 14c formed in the key frame 40B. Then, the input operation key members 14b are adhered to the convex portions 14d.

The key sheet 40C is a sheet-shaped member made of silicone rubber, which has flexibility. A plurality of convex portions 14d are formed in the key sheet 40C as described above. The plurality of convex portions 14d are formed on a surface of the key sheet 40C on a side where the key frame 40B is to be arranged. Each of the plurality of convex portions 14d is formed at a position corresponding to a key switch 52 described later.

The key substrate 50 has a plurality of key switches 51, 52 and 53 arranged on a first surface 50a, which is a surface on a key sheet 40C side thereof. Each of the plurality of key switches 51, 52 and 53 are respectively arranged at a position corresponding to an operation member 40A. The key switches 51, 52 and 53 arranged at the key substrate 50 have structures that have metal domes of metallic plates three-dimensionally formed so as to have a curved bowl shape. The metal dome is configured so that when the top of its bowl shape is pressed, it contacts the switch terminal formed on an electrical circuit (not illustrated) printed on the surface of the key substrate 50, and conducts electrically. In addition, a plurality of electrode wires is formed in the key substrate 50 on a second surface 50b thereof. This key substrate 50 is electrically connected with the circuit board 70 via the FPC portion 90 as a substrate.

The shielding case 60 is a rectangular shape as viewed in the plane, and is a low-profile box shape with a surface thereof on a circuit board 70 side open. This shielding case 60 is formed from a metallic material, and has electrical conductivity.

The circuit board 70 has the reference potential pattern layer 75 (first conductive portion) formed on one face 70a thereof. In addition, various electrical components (not illustrated) such as an RF module for portable telephones and an RF circuit portion 33 (circuit portion) that performs processing on high frequency signals are mounted on this circuit board 70.

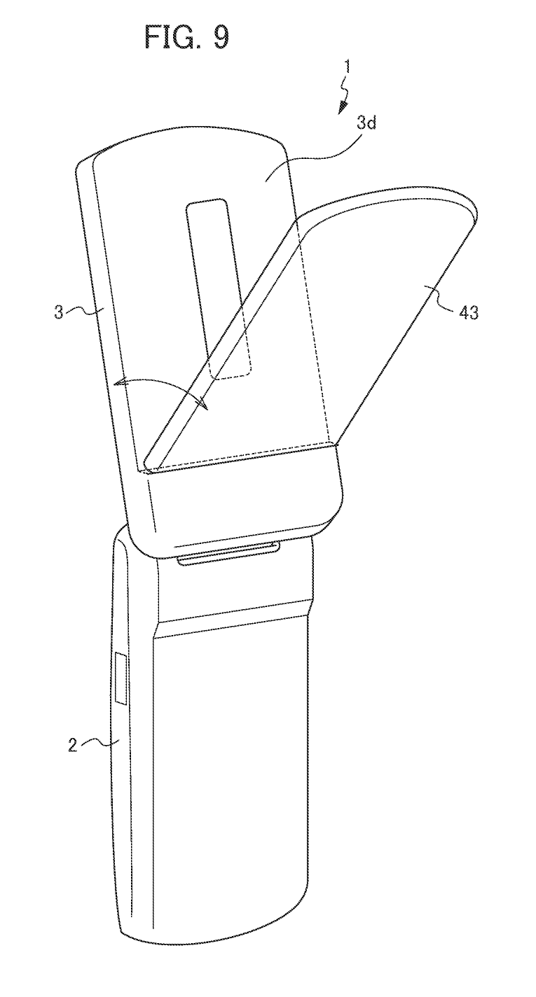

FIG. 3 is an exploded perspective view of the display unit side body 3. As shown in FIG. 3, the display unit side body 3 includes a front panel 3a, a front case 3b, the display 21, a circuit board 80 to which the display 21 is connected, a rear case 3c, and a rear panel 3d. In addition, the second case member 43 is connected to the outer surface of the rear panel 3d. This second case member 43 is connected to be relatively moveable in relation to the rear panel 3d (refer to FIG. 9). In addition, the front panel 3a, the front case 3b, the display 21, the circuit board 80, the rear case 3c and the rear panel 3d are arranged in layers in the display unit side body 3.

As shown in FIG. 3, the front case 3b and the rear case 3c are arranged so that the interior faces of concave shape face each other, and are joined together so that their outer peripheral edges overlap with each other. In addition, the display 21 and the circuit board 80 are housed so as to be sandwiched between the front case 3b and the rear case 3c. Moreover, a reference potential pattern layer (second conductive portion) is formed on the circuit board 80.

Furthermore, with the cellular telephone device 1, the circuit board 80 arranged inside of the display unit side body 3 and the circuit board 70 arranged inside of the operation unit side body 2 are electrically connected between the operation unit side body 2 and the display unit side body 3 by a flexible printed circuit board (Flexible Printed Circuits: hereinafter referred to as FPC) not illustrated.

It should be noted that, although FIG. 1 shows the form of a so-called folding-type cellular telephone device, the form of the cellular telephone device according to the present invention is not particularly limited, and may be a sliding type in which one of the bodies slides to one direction from a state where the operation unit side body 2 and the display unit side body 3 are overlapped with each other; a rotating (turning) type in which one of the bodies rotates about an axis along the overlapping direction of the operation unit side body 2 and the display unit side body 3; or the like.

The cellular telephone device 1 according to the present embodiment sets either side of the configuration related to the operation unit side body 2 and the configuration related to the display unit side body 3 as the radiating element of the antenna, and sets the other side as the ground portion of the antenna to configure one antenna from the entire body (e.g., a dipole antenna), and thus has a function of being able to simply carry out adjustment of the reception sensitivity.

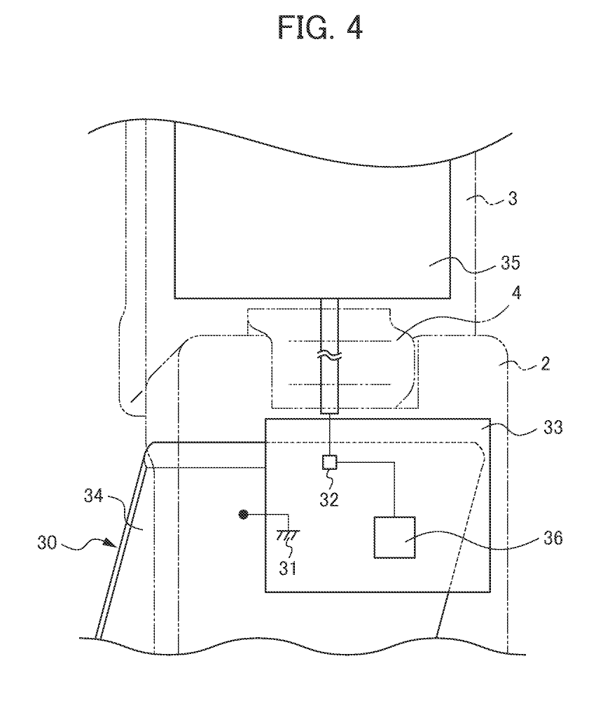

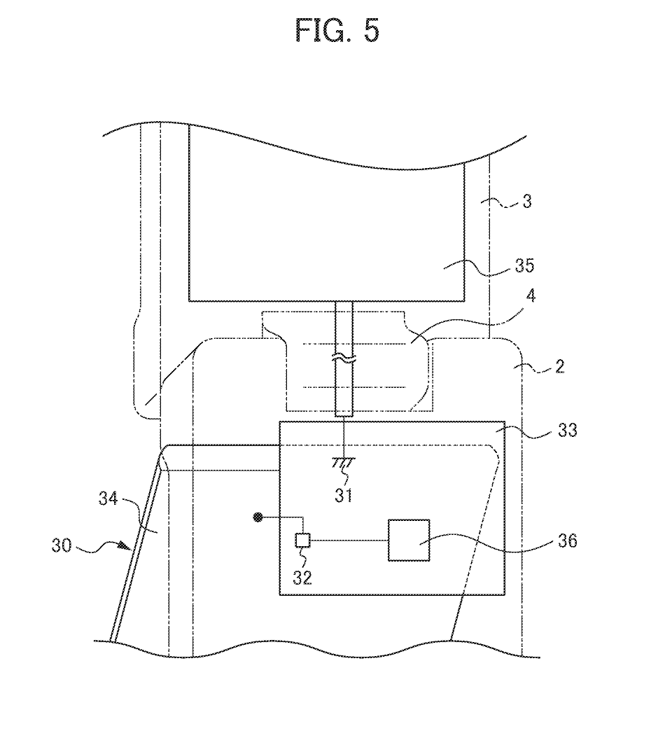

Herein, the configuration for realizing this function will be explained referring to the schematic views shown in FIGS. 4 to 16. It should be noted that, although the antenna configured according to the configuration related to the operation unit side body 2 and the configuration related to the display unit side body 3 is explained by assuming to be an antenna that receives digital terrestrial broadcasting hereinafter, for example, it is not limited thereto, and may be employed as another antenna such as the main antenna used in CDMA (Code Division Multiple Access) communication.

### First Embodiment

The cellular telephone device 1 has the operation unit side body 2, the display unit side body 3, the circuit portion 33, the first conductive portion 34, and the second conductive portion 35, as shown in FIG. 4. The operation unit side body 2 includes the first case member 30 configuring the exterior thereof. It should be noted that the second conductive portion 35 is configured by the conductive members or the like forming the ground pattern of a circuit board that is not illustrated, a shielding case, and the display unit side body 3, for example.

The circuit portion 33 is arranged in either one of the operation unit side body 2 and the display unit side body 3, and has a ground portion 31 and power feed portion 32, and a wireless circuit portion 36 as a signal processing unit. It should be noted that the wireless circuit portion 36 is established at the same potential as the ground portion 31 so that there is no influence on the antenna characteristics. The first conductive portion 34 is formed in the first case member 30, and is electrically connected to the ground portion 31. The second conductive portion 35 is arranged in the display unit side body 3, and is electrically connected to the power feed portion 32. In addition, signals supplied to the power feed portion 32 are supplied to the wireless circuit portion 36 configured to include an RF circuit, and predetermined processing is executed thereon. Furthermore, the entirety of the first case member 30 may be formed by the first conductive portion 34, or a portion thereof may be formed by the first conductive portion 34.

Since the display unit side body 3 is electrically connected to the power feed portion 32 via the second conductive portion 35 according to such a configuration, it realizes a function as a radiating element of the antenna. In addition, the first case member 30 realizes a function as a ground portion of the antenna due to being connected to the ground portion 31 via the first conductive portion 34.

Therefore, since the cellular telephone device 1 can employ the first case member 30 forming the exterior of the operation unit side body 2 as the ground portion of the antenna, a reduction in the complication of the body internal structure is possible in a case of configuring an antenna. In addition, since the cellular telephone device 1 employs the first case member 30 forming the exterior of the operation unit side body 2 as the ground portion of the antenna, the ground portion can be separated from various conductive members inside of the operation unit side body 2, and thus an improvement in antenna characteristics can be achieved compared to a case of the ground portion of the antenna being disposed inside of the operation unit side body 2.

It should be noted that, although it has been explained above that the ground portion 31 is provided to the circuit portion 33, and the first conductive portion 34 is electrically connected to the ground portion 31, the cellular telephone device 1 is not limited thereto. So long as the ground portion 31 and the first conductive portion 34 are the same potential, the first conductive portion 34 may be capacitatively coupled, without being directly connected to the ground portion 31.

In addition, it may be configured to set the first case member 30 as the radiating member of the antenna, and to set the operation unit side body 2 or display unit side body 3 as the ground portion of the antenna. In a case of being configured in this way, the first conductive portion 34 is formed in the first case member 30 and is electrically connected to the wireless circuit portion 36 via the power feed portion 32, and the second conductive portion 35 is disposed in the display unit side body 3 and is electrically connected to the ground portion 31.

In addition, with the cellular telephone device 1, it is preferable for the first case member 30 to be a configuration connected to the operation unit side body 2 to be relatively movable in relation to the operation unit side body 2. More specifically, the first case member 30 is a battery lid 2c, which houses a rechargeable battery in the rear case 2b (surface on which the group of operation keys 11 is not arranged) of the operation unit side body 2, and is connected to allow one end side to move relative to the operation unit side body 2, as shown in FIG. 6. In addition, the connection member connecting the operation unit side body 2 and the first case member 30 is configured by a mechanism allowing for angular adjustment. Therefore, the first case member 30 can be adjusted to a predetermined angle with reference to a plane of the operation unit side body 2.

Consequently, by causing the first case member 30 to relatively move in relation to the operation unit side body 2, the cellular telephone device 1 is able to adjust antenna characteristics as in a rod antenna externally mounted, and thus can achieve more effective utilization of the first case member 30. In addition, since the first case member 30 can be made to function also as a support member supporting the operation unit side body 2, for example, the cellular telephone device 1 can be stably placed on a desk or the like.

Furthermore, in the cellular telephone device 1, it is preferable for the first case member 30 to be formed from metal. By configuring in this way, the cellular telephone device 1 can also achieve an improvement in the strength of the operation unit side body 2 from the first case member 30 being formed from metal.

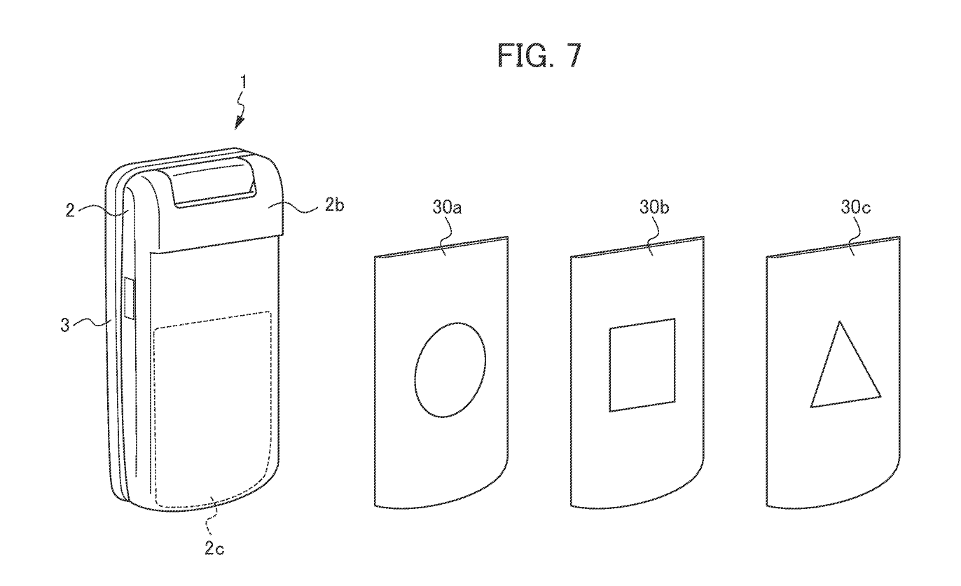

In addition, with the cellular telephone device 1, it is preferable for the first case member 30 to be a decoration case. For example, for the first case member 30, there is a case member 30a, a case member 30b, a case member 30c and the like differing in design, as shown in FIG. 7. Therefore, a user can arbitrarily exchange the first case member 30 according to their personal taste or usefulness in an application.

By being configured in this way, the cellular telephone device 1 can achieve effective utilization of the first case member 30 due to a decoration case configured to be detachable with the object of improving the design properties being used as the first conductive portion 34.

In addition, with the cellular telephone device 1, electrical conduction between the operation unit side body 2 and the display unit side body 3 is achieved by means of a thin coaxial cable, flexible cable or the like through the connection portion 4. Therefore, in a case of the circuit portion 33 being disposed in the display unit side body 3, the electrical connection to the operation unit side body 2 is achieved using the thin coaxial cable, flexible cable or the like.

### Second Embodiment

Next, a second embodiment will be explained. Although a case of the first case member 30 being formed in the operation unit side body 2 has been explained in the first embodiment, a case of a second case member 43, which shares the use, function and form with the first case member 30, being formed in the display unit side body 3 will be explained in the second embodiment.

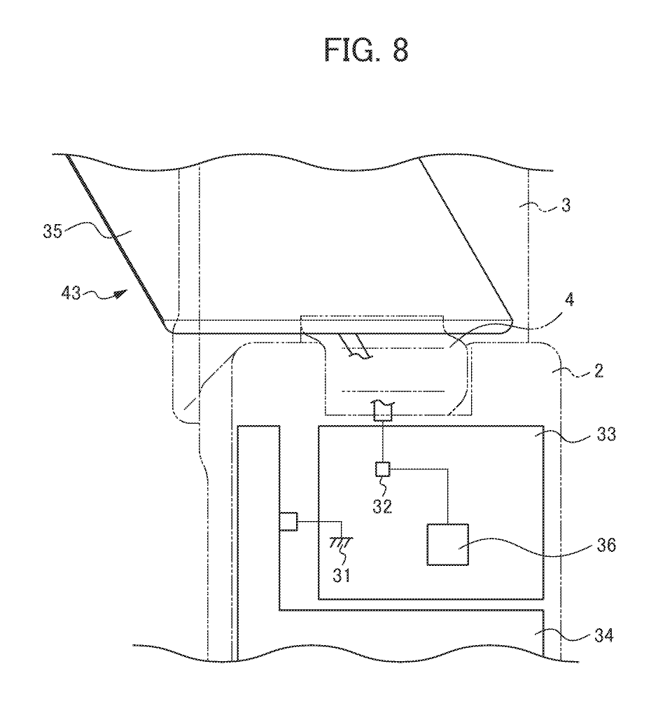

The cellular telephone device 1 includes the operation unit side body 2, the display unit side body 3, the circuit portion 33, the first conductive portion 34, and the second conductive portion 35, as shown in FIG. 8. It should be noted that the first conductive portion 34 is configured by the conductive members or the like forming the ground pattern of a circuit board that is not illustrated, a shielding case, and a conductive member forming the operation unit side body 2, for example.

The display unit side body 3 has the second case member 43 forming the exterior thereof. The circuit portion 33 is arranged in either one of the operation unit side body 2 and the display unit side body 3, and includes the ground portion 31, the power feed portion 32, and the wireless circuit portion 36. It should be noted that the wireless circuit portion 36 is established at the same potential as the ground portion 31 so that there is no influence on the antenna characteristics. The first conductive portion 34 is disposed in the operation unit side body 2, and is electrically connected to the ground portion 31. The second conductive portion 35 is disposed in the display unit side body 3, and is formed in the second case member 43 to be electrically connected to the power feed portion 32. In addition, signals supplied to the power feed portion 32 are supplied to the wireless circuit portion 36 configured to include an RF circuit, and predetermined processing is executed thereon. Furthermore, the entirety of the second case member 43 may be formed by the second conductive portion 35, or a portion thereof may be formed by the second conductive portion 35.

According to such a configuration, the second case member 43 realizes a function as a radiating element of the antenna due to being electrically connected to the power feed portion 32 via the second conductive portion 35. In addition, the operation unit side body 2 realizes a function as a ground portion of the antenna due to being connected to the ground portion 31 via the first conductive portion 34.

Therefore, the cellular telephone device 1 can employ the second case member 43 forming the exterior of the display unit side body 3 as the radiating element of the antenna. Consequently, the cellular telephone device 1 can reduce complication of the body internal structure in a case of configuring an antenna. In addition, since the cellular telephone device 1 employs the second case member 43 forming the exterior of the display unit side body 3 as the radiating element of the antenna, the radiating element of the antenna can be separated from various conductive members inside of the display unit side body 3, and thus an improvement in antenna characteristics can be achieved compared to a case of the radiating element of the antenna being disposed inside of the display unit side body 3.

It should be noted that, although it has been explained above that the ground portion 31 is provided to the circuit portion 33, and the first conductive portion 34 is electrically connected to the ground portion 31, the cellular telephone device 1 is not limited thereto. So long as the ground portion 31 and the first conductive portion 34 are the same potential, the first conductive portion 34 may not be directly connected to the ground portion 31.

In addition, with the cellular telephone device 1, it is preferable for the second case member 43 to be a configuration connected to the display unit side body 3 to be relatively movable in relation to the display unit side body 3. More specifically, the second case member 43 is a top surface of the rear panel 3d of the display unit side body 3 (surface on which the display 21 is not arranged), and is connected to allow one end side to move relative to the display unit side body 3, as shown in FIG. 9. In addition, the connection member connecting the display unit side body 3 and the second case member 43 is configured by a mechanism allowing for angular adjustment. Therefore, the second case member 43 can be adjusted to a predetermined angle with reference to a plane of the operation unit side body 2.

Consequently, by causing the second case member 43 to relatively move in relation to the display unit side body 3, the cellular telephone device 1 is able to adjust antenna characteristics as in a rod antenna externally mounted. Therefore, the cellular telephone device 1 can achieve more effective utilization of the second case member 43. In addition, since the second case member 43 can be made to function also as a support member supporting the display unit side body 3, for example, the cellular telephone device 1 can be stably placed on a desk or the like.

Furthermore, in the cellular telephone device 1, it is preferable for the second case member 43 to be formed from metal. Therefore, the cellular telephone device 1 can also achieve an improvement in the strength of the display unit side body 3 from the second case member 43 being formed from metal.

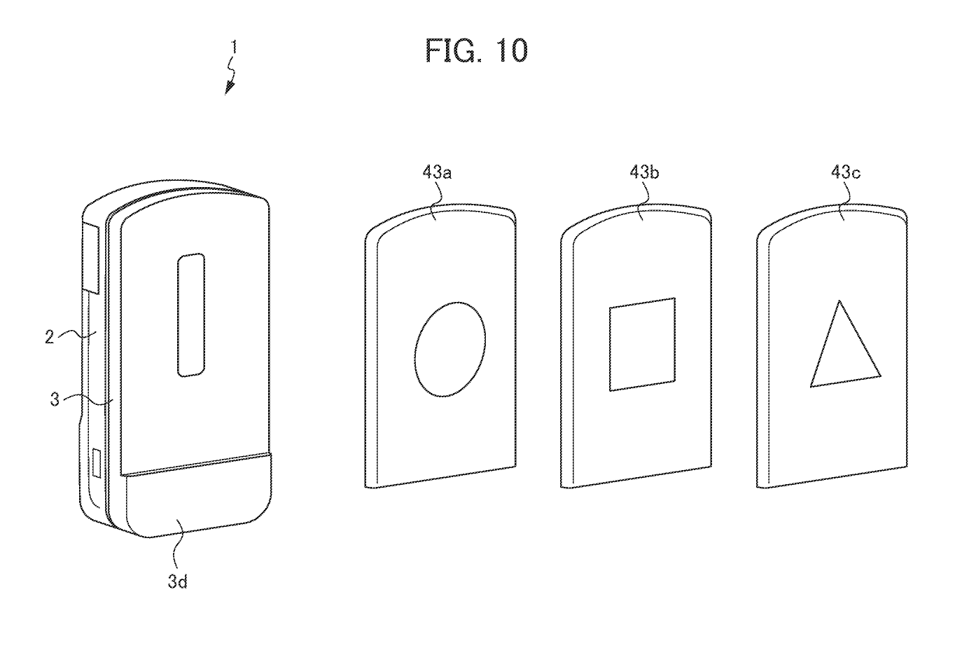

In addition, with the cellular telephone device 1, it is preferable for the second case member 43 to be a decoration case. For example, for the second case member 43, there is a case member 43a, a case member 43b, a case member 43c and the like differing in design, as shown in FIG. 10. Therefore, a user can arbitrarily exchange the second case member 43 according to their personal taste or usefulness in an application.

By being configured in this way, the cellular telephone device 1 can achieve effective utilization of the second case member 43 due to a decoration case configured to be detachable with the object of improving the design properties being used as the first conductive portion 34.

### Third Embodiment

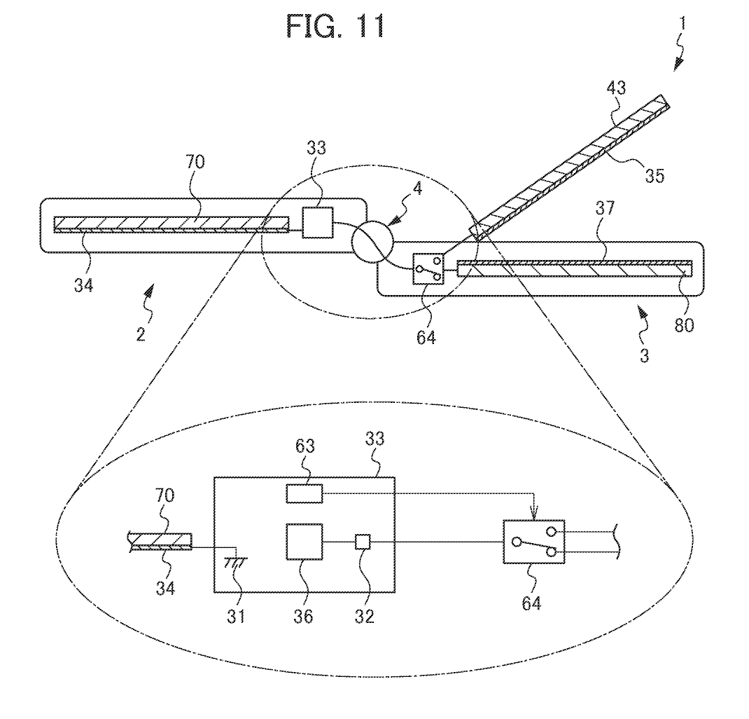

Next, a third embodiment will be explained. The basic configuration thereof is the configuration explained in the second embodiment. In the third embodiment, in addition to the second conductive portion 35 formed in the second case member 43, the cellular telephone device 1 has a third conductive portion 37 formed in the circuit board 80 housed in the display unit side body 3. The cellular telephone device 1 includes a selector switch 64 as a selector portion that is configured to be able to select between a first connection state in which the second case member 43 (second conductive portion 35) and the power feed portion 32 are connected, and a second connection state in which the circuit board 80 (third conductive portion 37) and the power feed portion 32 are connected, and a control unit 63 that controls selection of the first connection state or the second connection state by way of this selector switch 64, as shown in FIG. 11.

In addition, a circuit board 70 housed in the operation unit side body 2 is electrically connected to the ground portion 31, and thus realizes a function as a ground portion of the antenna. Furthermore, the second case member 43 and the circuit board 80 are both electrically connected to the power feed portion 32 via the selector switch 64 and realize a function as radiating elements of the antenna.

Herein, operation of the control unit 63 will be explained. The control unit 63 controls the selector switch 64 in order to set the second case member 43 as a radiating element of the antenna, connects the second conductive portion 35 related to the second case member 43 to the wireless circuit portion 36, and detects a resonance sensitivity (reception sensitivity) A. In addition, the control unit 63 controls the selector switch 64 in order to set the circuit board 80 as the radiating element of the antenna, connects the third conductive portion 37 related to the circuit board 80 to the wireless circuit portion 36, and detects a resonance sensitivity (reception sensitivity) B. The control unit 63 compares the resonance sensitivity A with the resonance sensitivity B, and controls the selector switch 64 so that the second case member 43 becomes a radiating element of the antenna in a case of the resonance sensitivity A being higher than the resonance sensitivity B, and controls the selector switch 64 so that the circuit board 80 becomes a radiating element of the antenna in a case of the resonance sensitivity A being lower than the resonance sensitivity B. It should be noted that the control unit 63 executes the comparison between the resonance sensitivity A and the resonance sensitivity B at a predetermined time interval (e.g., interval for performing intermittent reception performed at predetermined period).

Therefore, since the cellular telephone device 1 has a function (diversity receiving function) of adaptively switching the radiating element of the antenna to the second case member 43 or the circuit board 80 according to the resonance sensitivity, it can obtain the optimum reception sensitivity.

Furthermore, since control by the control unit 63 is performed during intermittent reception performed at the predetermined period, it is not necessary to supply electric power only to execute operation of the control unit 63 according to the present embodiment, and thus the cellular telephone device 1 can achieve a power savings. In addition, the cellular telephone device 1 can continuously suppress a decline in antenna characteristics due to control being performed at a predetermined period.

In addition, the control unit 63 may be a configuration that switches the selector switch 64 based not on the resonance sensitivity, but rather on the contact state, a temperature change or a brightness change. More specifically, the cellular telephone device 1 includes a detection unit (not illustrated) that detects the contact state, a temperature change or a brightness change.

### Detection of Contact State

In order to detect contact by a user, the detection unit arranges a detection element that is a touch sensor at the second case member 43 and a predetermined portion (portion likely to be contacted by the user) of the display unit side body 3 other than the second case member 43, and detects contact of the user by way of the detection element. The control unit 63 controls the selector switch 64 so that the circuit board 80 becomes the radiating element of the antenna, in a case of having detected that the second case member 43 is contacted by way of the detection unit. In addition, the control unit 63 controls the selector switch 64 so that the second case member 43 becomes the radiating member of the antenna in a case of having detected that the display unit side body 3 is contacted by way of the detection unit.

### Detection of Temperature Change

In addition, in order to detect contact by the user, the detection unit arranges a detection element that is a temperature sensor at the second case member 43 and a predetermined portion (portion likely to be contacted by user) of the display unit side body 3 other than the second case member 43, and detects a temperature change by way of the detection element. The control unit 63 controls the selector switch 64 so that the circuit board 80 becomes the radiating element of the antenna in a case of having detected that the second case member 43 is a temperature within a predetermined temperature range (e.g., 30° C. to 40° C.) by way of the detection unit. In addition, the control unit 63 controls the selector switch 64 so that the second case member 43 becomes the radiating element of the antenna in a case of having detected that the display unit side body 3 is a temperature within a predetermined temperature range (e.g., 30° C. to 40° C.) by way of the detection unit.

### Detection of Brightness Change

In addition, in order to detect contact by the user, the detection unit arranges a detection element that is a sensor (photosensor) that detects luminance at the second case member 43 and a predetermined portion (portion likely to be contacted by the user) of the display unit side body 3 other than the second case member 43, and detects a brightness change by way of the detection element. The control unit 63 controls the selector switch 64 so that the circuit board 80 becomes the radiating element of the antenna in a case of having detected that the periphery of the second case member 43 is a brightness no more than a predetermined brightness by way of the detection unit. In addition, the control unit 63 controls the selector switch 64 so that the second case member 43 becomes the radiating element of the antenna in a case of having detected that the periphery of the display unit side body 3 being a brightness no more than a predetermined brightness by way of the detection unit.

Since the radiating element of the antenna is selected based on the contact state, temperature or brightness with the cellular telephone device 1 configured in this way, a decline in antenna characteristics can be suppressed in response to the usage mode by the user. It should be noted that the cellular telephone device 1 may be a configuration integrally using a touch sensor, temperature sensor and photosensor.

### Fourth Embodiment

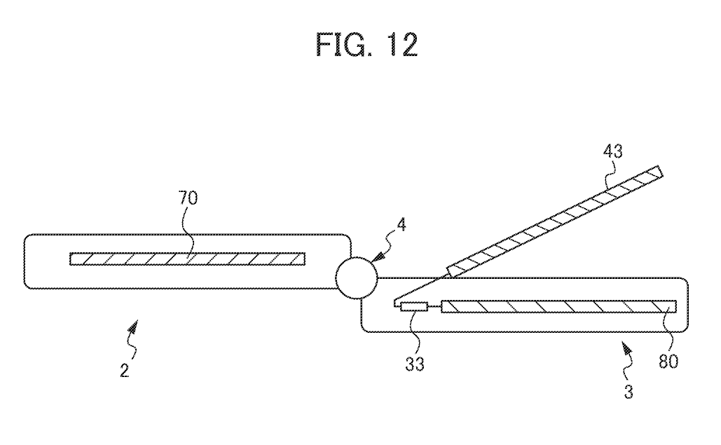

In addition, the cellular telephone device 1 may be a configuration that arranges the circuit portion 33 configured to include the wireless circuit portion 36 in the display unit side body 3, and form the radiating element and the ground portion of the antenna only in the display unit side body 3, as shown in FIG. 12. In the case of this configuration, the control unit 63 switches so that the circuit board 80 becomes the radiating element of the antenna, and switches so that the second case member 43 becomes the ground portion of the antenna, and also switches so that the second case member 43 becomes the radiating element of the antenna and switches the circuit board 80 to the ground portion of the antenna, as required. It should be noted that the second conductive portion and the third conductive portion are not limited to the second case member 43 and the circuit board 80. In other words, the second conductive portion and the third conductive portion may be configured by another conductive member (e.g., shielding case 60, etc.) constituting the display unit side body 3.

Since high frequency current tends not to flow in the operation unit side body 2 by configuring in this way, degradation in the antenna characters can be avoided even if the operation unit side body 2 is covered by a hand or the like of the user. As has been explained above, the selector switch 64 serving as a selector portion is configured to be able to select a plurality of connection states (first connection state, second connection state, and third connection state) in which the second conductive portion 35, third conductive portion 37 and power feed portion 32 are selectively connected. In addition, the control unit 63 controls the selection of the plurality of connection states by way of the selector switch 64. The portable terminal according to the present invention is not limited to the aforementioned configuration, and maybe a configuration such as that illustrated below.

### Fifth Embodiment

Next, a fifth embodiment will be explained. The basic configuration thereof is the configuration explained in the third embodiment. In the fifth embodiment, the configurations of the control unit 63 and the selector switch 64 differ from the third embodiment.

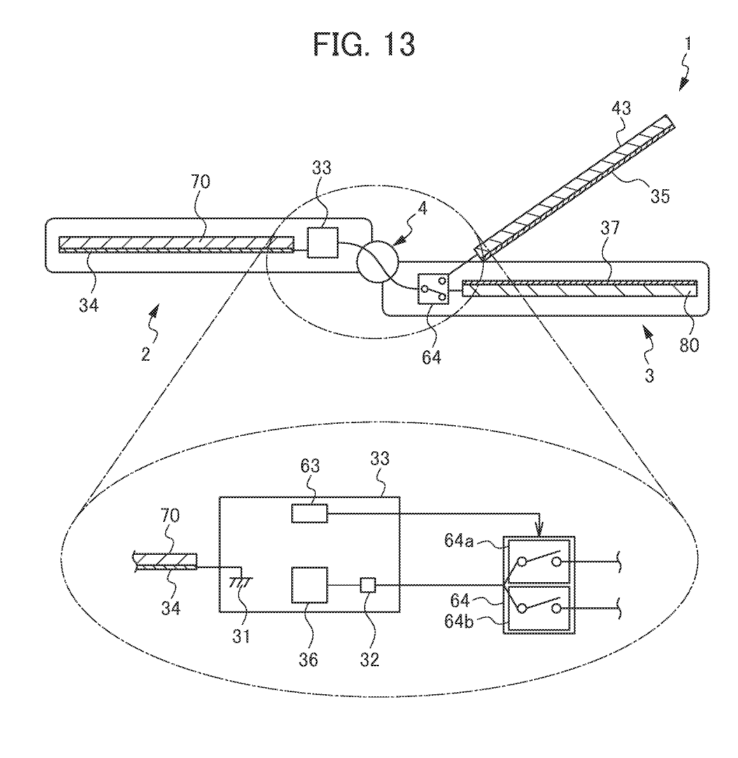

As shown in FIG. 13, in the fifth embodiment, the selector switch 64 includes a first switch 64a and a second switch 64b.

The first switch 64a and the second switch 64b are configured to be able to select between a first connection state in which the second conductive portion 35 and the power feed portion 32 are connected, a second connection state in which the third conductive portion 37 and the power feed portion 32 are connected, and a third connection state in which the second conductive portion 35 and the third conductive portion 37 are connected with the power feed portion 32. In addition, in the selector switch 64, an power feed portion 32 side of the first switch 64a and an power feed portion 32 side of the second switch 64b are connected.

Furthermore, the control unit 63 controls the first switch 64a and the second switch 64b according to the useable frequency band.

More specifically, similarly to the third embodiment, the control unit 63 controls the first switch 64a to the ON state in order to set the second case member 43 as the radiating element of the antenna, whereby the control unit 63 connects the second conductive portion 35 relating to the second case member 43 to the wireless circuit portion 36 (power feed portion 32) (first connection state). In addition, the control unit 63 controls the second switch 64b to the ON state in order to set the circuit board 80 as the radiating element of the antenna, thereby connecting the third conductive portion 37 relating to the circuit board 80 to the wireless circuit portion 36 (power feed portion 32) (second connection state). Furthermore, the control unit 63 controls both the first switch 64a and the second switch 64b to the ON state in order to integrate the second case member 43 and the circuit board 80 and set as the radiating element of the antenna, thereby connecting the second conductive portion 35 relating to the second case member 43 and the third conductive portion 37 relating to the circuit board 80 to the wireless circuit portion 36 (power feed portion 32) (third connection state).

It should be noted that “controls the first switch 64a to the ON state” indicates controlling the power feed portion 32 side of the first switch 64a and the second case member 43 to a conductive state. Similarly, “controls the second switch 64b to the ON state” indicates controlling the power feed portion 32 side of the second switch 64b and the second case member 43 to a conductive state.

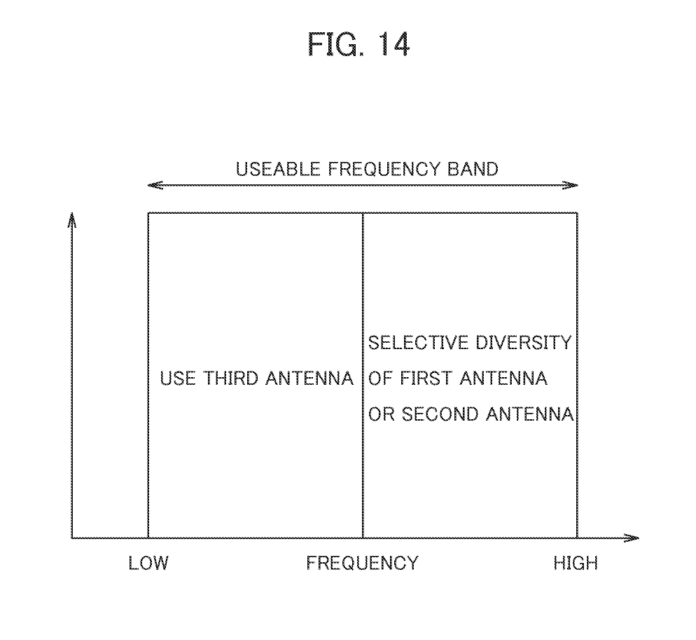

Herein, as shown in FIG. 13 or FIG. 14, since the cellular telephone device 1 either selects a case of setting the second case member 43 as the radiating element of the antenna (first antenna in FIG. 14), and a case of setting the circuit board 80 as the radiating element of the antenna (second antenna in FIG. 14), it has a function (selective diversity receiving function) of adaptively selecting the radiating element of the antenna as the second case member 43 or the circuit board 80 according to the resonance sensitivity.

Furthermore, the cellular telephone device 1 integrates the second case member 43 and the circuit board 80 and sets them as the radiating element of the antenna (third antenna in FIG. 14). The radiating element of the antenna integrating the second case member 43 and the circuit board 80 thereby has a longer electrical length compared to the case of setting the second case member 43 as the radiating element of the antenna, or the case of setting the circuit board 80 as the radiating element of the antenna. As a result, with the radiating element of the antenna integrating the second case member 43 and the circuit board 80, as shown in FIG. 14, for example, a signal of a lower useable frequency band can be received compared to the case of setting the second case member 43 as the radiating element of the antenna or the case of setting the circuit board 80 as the radiating element of the antenna.

For example, in a case of receiving a signal of a broad useable frequency band such as that of television broadcast waves (digital terrestrial broadcast waves), the control unit 63 measures the useable frequency band, and determines whether the useable frequency band thus measured is no more than a predetermined threshold.

Then, in a case of the useable frequency band being no more than the predetermined threshold, the control unit 63 selects the third connection state by controlling both the first switch 64a and the second switch 64b to the ON state, to set a radiating element of the antenna integrating the second case member 43 and the circuit board 80.

On the other hand, in a case of the useable frequency band exceeding the predetermined threshold, the control unit 63 selects the first connection state or the second connection state by controlling the first switch 64a or the second switch 64b to the ON state, to set the second case member 43 or the circuit board 80 as the radiating element of the antenna. Which of the first connection state and the second connection state is selected may be based on the reception sensitivity, or may be based on a setting established in advance.

### Sixth Embodiment

Next, a sixth embodiment will be explained. The basic configuration thereof is the configuration explained in the third embodiment. In the sixth embodiment, the aspect of including a selector switch 65 in place of the selector switch 64 and the configuration of the circuit portion 33 differ from the third embodiment.

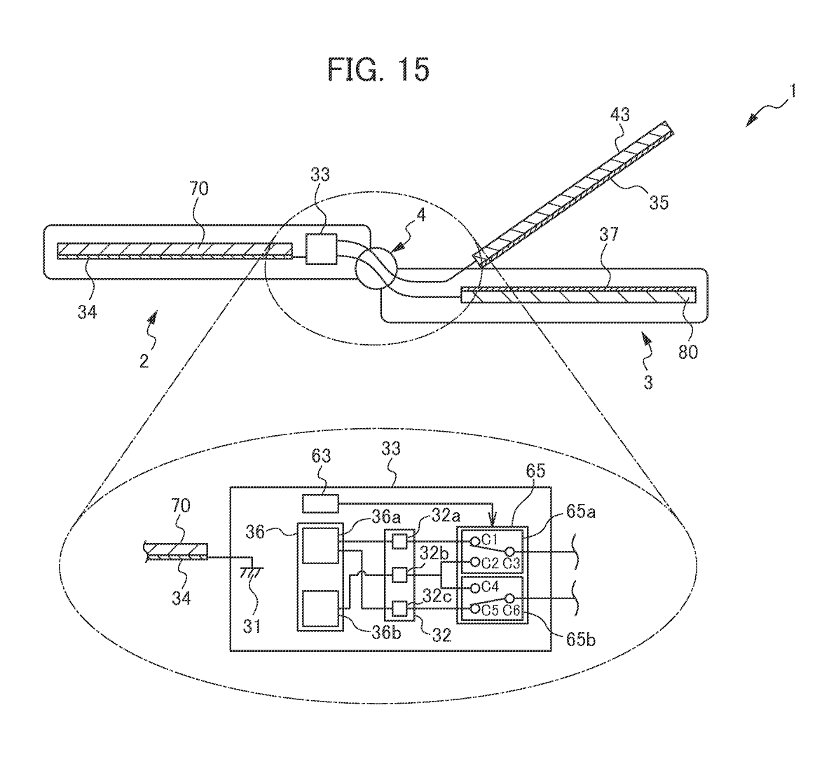

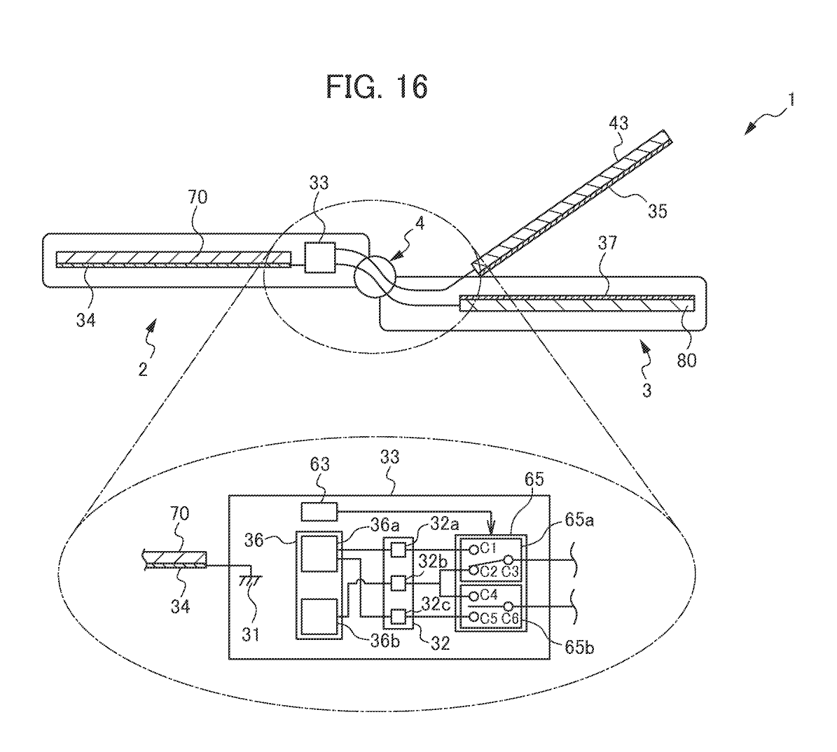

As shown in FIGS. 15 and 16, in the sixth embodiment, the circuit portion 33 includes the power feed portion 32, the wireless circuit portion 36, the control unit 63, and the selector switch 65 as a selector portion. The wireless circuit portion is configured to include a processing unit 36a and a processing unit 36b.

The processing unit 36a performs processing on signals received by the second case member 43 and circuit board 80, in a case of the second case member 43 and the circuit board 80 being set as the radiating elements of the antenna (combined diversity). The processing unit 36b performs processing on signals received by the second case member 43 or the circuit board 80, in a case of the second case member 43 or the circuit board 80 being set as the radiating element of the antenna (selective diversity).

The selector switch 65 includes a third switch 65a and a fourth switch 65b. The third switch 65a has a contact C1, contact C2 and contact C3. The fourth switch 65b has a contact C4, contact C5 and contact C6.

The power feed portion 32 is configured to include a matching circuit 32a, a matching circuit 32b and a matching circuit 32c.

One end of the matching circuit 32a is connected with the processing unit 36a, and the other end side is connected with the contact C1 of the third switch 65a. The matching circuit 32a tunes the signal received by the second case member 43, in a case of the second case member 43 being set as the radiating element of the antenna. One end side of the matching circuit 32b is connected with the processing unit 36b, and the other end side is connected with the contact C2 of the third switch 65a and the contact C4 of the fourth switch 65b. The matching circuit 32b tunes the signal received by the second case member 43 and the circuit board 80, in a case of the second case member 43 and the circuit board 80 being set as the radiating elements of the antenna. One end side of the matching circuit 32c is connected with the processing unit 36a, and the other end side is connected with the contact C5 of the fourth switch 65b. The matching circuit 32c tunes the signal received by the circuit board 80, in a case of the circuit board 80 being set as the radiating element of the antenna.

The third switch 65a and the fourth switch 65b are configured to be able to select between a fourth state in which the second conductive portion 35 and the matching circuit 32a are connected and the third conductive portion 37 and the matching circuit 32c are connected (combined diversity), and a fifth connection state in which the second conductive portion 35 and the matching circuit 32b are connected or the third conductive portion 37 and the matching circuit 32b are connected (selective diversity). The control unit 3 controls the selector switch 65 so as to select either the fourth connection state or the fifth connection state, based on a predetermined condition.

Herein, combined diversity is preferable in a case of receiving a weak electric field signal, and selective diversity is preferable in a case of receiving a faded signal. As a result, it is preferable to select combined diversity under an environment receiving a weak electric field signal. In addition, under an environment receiving a medium-to-weak electric field signal, it is preferable to select selective diversity due to combined diversity requiring use of complex algorithms in the processing unit 36a, and having high electric power consumption.

Specifically, in order to set the second case member 43 and the circuit board 80 as the radiating element of the antenna, the control unit 63 controls to a state of the third switch 65a in which the contact C1 and the contact C3 are connected and a state of the fourth switch 65b in which the contact C5 and the contact C6 are connected, thereby connecting the second conductive portion 35 relating to the second case member 43 to the processing unit 36a (matching circuit 32a), and connecting the third conductive member 37 relating to the circuit board 80 to the processing unit 36a (matching circuit 32c) (fourth connection state; refer to FIG. 15).

In addition, in order to set the second case member 43 or the circuit board 80 as the radiating element of the antenna, the control unit 63 controls to a state of the third switch 65a in which the contact C2 and the contact C3 are connected, or a state of the fourth switch 65b in which the contact C4 and the contact C6 are connected, thereby connecting the second conductive portion 35 relating to the second case member 43 to the processing unit 36b (matching circuit 32b), or connecting the third conductive portion 37 relating to the circuit board 80 to the processing unit 36b (matching circuit 32b) (fifth connection state; refer to FIG. 16).

Herein, the following conditions indicated in (1) to (3) can be used as the predetermined condition.

(1) Use of Threshold Value of Resonance Sensitivity as Predetermined Condition

The control unit 63 detects a resonance sensitivity (reception sensitivity) C in the fourth connection state. Then, in a case of the resonance sensitivity C having become no more than a threshold value T at which a signal can be suitably received in the fourth state, the control unit controls the third switch 65a and the fourth switch 65b so as to select the fifth connection state.

(2) Comparison of Resonance Sensitivity as Predetermined Condition

The control unit 63 detects the resonance sensitivity C in the fourth connection state. In addition, the control unit 63 detects a resonance sensitivity (reception sensitivity) D in the fifth connection state. Then, the control unit 63 compares the resonance sensitivity C with the resonance sensitivity D, and in a case of the resonance sensitivity C being higher than the resonance sensitivity D, controls the third switch 65a and the fourth switch 65b so as to select the fourth connection state, and in a case of the resonance sensitivity C being lower than the resonance sensitivity D, controls the third switch 65a and the fourth switch 65b so as to select the fifth connection state. It should be noted that the control unit 63 executes comparison of the resonance sensitivity C with the resonance sensitivity D at predetermined time intervals (e.g., interval of performing intermittent reception performed at predetermined period).

(3) Use of Connection State, Change in Temperature or Brightness as Predetermined Condition

Similarly to the aforementioned third embodiment, it may be a configuration that switches the third switch 65a and the fourth switch 65b based not on the resonance sensitivity, but rather on the contact state, a temperature change or a brightness change. More specifically, the cellular telephone device 1 includes a detection unit (not illustrated) that detects a contact state, temperature change or brightness change.

In a case of detecting the contact state, the control unit 63 controls the third switch 65a and the fourth switch 65b so that the circuit board 80 becomes the radiating element of the antenna in the fourth connection state or the fifth connection state, in a case of having detected by way of the detection unit that the second case member 43 is being contacted. In addition, the control unit 63 controls the third switch 65a and the fourth switch 65b so that the second case member 43 becomes the radiating member of the antenna in the fourth connection state or the fifth connection state, in a case of having detected by way of the detection unit that the display unit side body 3 is being contacted.

In a case of detecting a temperature change, the control unit 63 controls the third switch 65a and the fourth switch 65b so that the circuit board 80 becomes the radiating element of the antenna in the fourth connection state or the fifth connection state, in a case of having detected by way of the detection unit that the second case member 43 is a temperature within a predetermined temperature range (e.g., 30° C. to 40° C.) In addition, the control unit 63 controls the third switch 65a and the fourth switch 65b so that the second case member 43 becomes the radiating element of the antenna in the fourth connection state or the fifth connection state, in a case of having detected by way of the detection unit that the display unit side body 3 is a temperature within a predetermined temperature range (e.g., 30° C. to 40° C.)

In a case of detecting a brightness change, the control unit 63 controls the third switch 65a and the fourth switch 65b so that the circuit board 80 becomes the radiating element of the antenna in the fourth connection state or the fifth connection state, in a case of having detected by way of the detection unit that the periphery of the second case member 43 is a brightness no more than a predetermined brightness. In addition, the control unit 63 controls the third switch 65a and the fourth switch 65b so that the second case member 43 becomes the radiating element of the antenna in the fourth connection state or the fifth connection state, in a case of having detected by way of the detection unit that the periphery of the display unit side body 3 is a brightness no more than a predetermined brightness.

Furthermore, the following conditions indicated in (4) and (5) may be used in place of the above-mentioned predetermined conditions indicated in (1) to (3).

(4) Use of Electric Power Consumption Status

In a case of transitioning to a power saving mode that suppresses electric power consumption of the entire cellular telephone device 1 or in a case of the remaining amount of voltage of a battery 81 having become low, the control unit 63 controls the third switch 65a and the fourth switch 65b in order to suppress electric power consumption, and does not select the fourth connection state and fifth connection state. On the other hand, in a case of the battery 81 being recharged, the control unit 63 controls the third switch 65a and the fourth switch 65b to select the fourth connection state or the fifth connection state.

(5) Use of Application Program

The control unit 63 may allow the user to select switching of the fourth connection state or fifth connection state by way of a predetermined application program. Herein, an application program for receiving television broadcast waves (digital terrestrial broadcast waves), for example, can be used as the predetermined application program. It should be noted that the aforementioned conditions (1) to (5) may be used as independent conditions, or may be used by combining a plurality of conditions.

In this way, the cellular telephone device 1 would select between combined diversity and selective diversity using predetermined conditions. Therefore, the cellular telephone device 1 can achieve a further improvement in reception sensitivity according to the state of resonance sensitivity.

### EXPLANATION OF REFERENCE NUMERALS

1 cellular telephone device

2 operation unit side body (first body)

3 display unit side body (second body)

30 first case member

31 ground portion

32 power feed portion

33 circuit portion

34 first conductive portion

35 second conductive portion

36 wireless circuit portion (signal processing unit)

37 third conductive portion

43 second case member

63 control unit

64 selector switch (selector portion)

1. A portable terminal comprising:
a first body;
a second body;
a circuit portion that is disposed in either of the first body and the second body, and comprises a ground portion, a power feed portion, and a signal processing unit connected to the power feed portion;
a first conductive portion that is disposed in the first body and is electrically connected to the ground portion;
a second conductive portion and a third conductive portion that are disposed in the second body;
a selector portion that can select a connection state of the second conductive portion and the third conductive portion with the power feed portion; and
a control unit that controls selection of the connection state by way of the selector portion.

2. A portable terminal according to claim 1,
wherein the selector portion can select between a first connection state in which the second conductive portion and the power feed portion are connected, and a second connection state in which the third conductive portion and the power feed portion are connected, and
wherein the control unit compares between a reception sensitivity in the first connection state and a reception sensitivity in the second connection state, and controls the selector portion so as to select a connection state which is a higher reception sensitivity.

3. A portable terminal according to claim 1,
wherein the selector portion can select a third connection state in which the second conductive portion and the third conductive portion are connected with the power feed portion, and
wherein the control unit controls the selector portion to select the third connection state in a case of a useable frequency band being no more than a predetermined value.

4. A portable terminal according to claim 1,
wherein the selector portion can select between a fourth connection state in which the second conductive portion and the power feed portion are connected and the third conductive portion and the power feed portion are connected, and a fifth connection state in which the second conductive portion and the power feed portion are connected or the third conductive portion and the power feed portion are connected, and
wherein the control unit controls the selector portion so as to select either the fourth connection state or the fifth connection state based on a predetermined condition.

5. A portable terminal according to claim 4, wherein the control unit uses whether or not a reception sensitivity in the fourth connection state is no more than a predetermined threshold value as the predetermined condition, and controls the selector portion so as to select the fifth connection state in a case of the reception sensitivity in the fourth connection state being no more than the predetermined threshold value.

6. A portable terminal according to claim 4, wherein the control unit uses a comparison between a reception sensitivity in the fourth connection state and a reception sensitivity in the fifth connection state as the predetermined condition, and controls the selector portion so as to select a connection state which is a higher reception sensitivity.

7. A portable terminal according to claim 4,
wherein a case member is disposed in the second body, and
wherein the control unit uses detection of contact with the second body and the case member as the predetermined condition, and controls the selector portion so as to select the third conductive portion and the power feed portion in the fourth connection state and the fifth connection state in a case of contact with the second body being detected, and controls the selector portion so as to select the second conductive portion and the power feed portion in the fourth connection state and the fifth connection state in a case of contact with the case body being detected.

8. A portable terminal according to claim 4, wherein the control unit uses whether or not to suppress electric power consumption of the portable terminal as the predetermined condition, and controls the selector portion so as not to select the fourth connection state and the fifth connection state in a case of suppressing electric power consumption, and so as to select the fourth connection state or the fifth connection state in a case of not suppressing electric power consumption.

9. A portable terminal according to claim 4, wherein the control unit controls the selector portion so as to select the fourth connection state or the fifth connection state based on an input operation related to a predetermined application program as the predetermined condition.

10. A portable terminal according to claim 1,
wherein a case member is disposed in the second body, and
wherein either one of the second conductive portion and the third conductive portion is formed at the case member.

11. A portable terminal according to claim 10, wherein the case member is coupled to the second body to be relatively moveable in relation to the second body.

12. A portable terminal according to claim 10, wherein the case member is formed of a metal.

13. A portable terminal according to claim 10, wherein the case member is a decoration case.
